(19) United States
(12) Patent Application Publication
(10) Pub. No.: US 2020/0358933 A1
(43) Pub. Date: Nov. 12, 2020

(54) IMAGING DEVICE AND ELECTRONIC APPARATUS

(71) Applicant: SONY SEMICONDUCTOR SOLUTIONS CORPORATION, KANAGAWA (JP)

(72) Inventors: NORIHIRO TANABE, TOKYO (JP); YOSHIKUNI NOMURA, TOKYO (JP)

(21) Appl. No.: 16/961,521

(22) PCT Filed: Dec. 7, 2018
(86) PCT No.: PCT/JP2018/045092

§ 371 Date: Jul. 10, 2020

(30) Foreign Application Priority Data
Jan. 26, 2018 (JP) 2018-011302

(51) Int. Cl. H04N 5/225; G02B 27/10; G02B 5/08

(52) U.S. Cl. CPC H04N 5/2254; G02B 5/08; G02B 27/10

(57) ABSTRACT

An imaging device includes: a beam splitter having a light incident surface on which light from an object is incident; a reflection mirror for returning light transmitted through the beam splitter to the beam splitter side; a first imaging part including a first lens, the first imaging part being arranged on a first emission surface side of the beam splitter in which the light from the light incident surface side is reflected and emitted; and a second imaging part including a second lens, the second imaging part being arranged on a second emission surface side of the beam splitter in which the light from the reflection mirror side is reflected and emitted. An optical distance of the light from the light incident surface to the first lens is set to be substantially equal to an optical distance of the light from the light incident surface to the second lens.

### TECHNICAL FIELD

The present disclosure relates to an imaging device and an electronic apparatus.

### BACKGROUND ART

In recent years, it has been proposed to perform image processing using an imaging device having a so-called compound eye configuration on the basis of an image captured by each imaging part. In a case where processing such as images from imaging parts are synthesized to attain improvement of an S/N ratio and higher resolution, it is desirable that the images from the imaging parts have no spatial deviation. However, in a configuration in which a pair of imaging parts are arranged side by side, spatial deviation occurs in images from the imaging parts.

FIG. 13 is a schematic diagram for explaining an image formation state of an imaging device in which a first imaging part including a first imaging element SA and a lens LA and a second imaging part including a second imaging element SB and a lens LB are arranged side by side with a distance D therebetween. In a case where a distant object OBJ₁ and a near object OBJ₂ on an optical axis of the lens LB are imaged, in the second imaging element SB, images of both the objects are formed at the center of the second imaging element SB. In other words, an image formation position is not related to an object distance. On the other hand, in the first imaging element SA, an incident angle of view changes according to a distance to the distant object OBJ₁ and a distance to the near object OBJ₂. As a result, deviation occurs in image formation positions. As described above, in the configuration in which the pair of imaging parts are arranged side by side, parallax occurs between the images, and furthermore, a difference also occurs in a state in which an object in front hides an object behind (so-called occlusion). Due to these effects, spatial deviation occurs between the images.

For example, Patent Document 1 discloses an imaging device having a compound eye configuration capable of reducing deviation between images caused by the parallax or occlusion described above. A basic structure of this imaging device is described with reference to FIG. 14. This imaging device includes a beam splitter BS, a reflection mirror ML, an imaging element SA and a lens LA, and an imaging element SB and a lens LB. A part of light incident on the beam splitter BS is reflected on a reflection surface RS, whereby the light is incident on the imaging element SA and the lens LA. On the other hand, light transmitted through the beam splitter BS is incident on the beam splitter BS again by the reflection mirror ML and then reflected on the reflection surface RS of the beam splitter BS, whereby the light is incident on the imaging element SB and the lens LB. In this configuration, optical axes of the imaging element SA and the imaging element SB optically coincide with each other. Therefore, parallax does not occur between images.

### CITATION LIST

### Patent Document

Patent Document 1: Japanese Patent Application Laid-Open No. 2017-187771

### SUMMARY OF THE INVENTION

### Problems to be Solved by the Invention

As described above, in the imaging device having the compound eye configuration using the beam splitter, since the optical axes of the first imaging part and the second imaging part can be set to coincide with each other, the parallax does not occur between the images. However, a phenomenon in which deviation occurs between images according to distances to objects can happen depending on a positional relationship of each imaging part with respect to the beam splitter.

Therefore, it is an object of the present disclosure to provide an imaging device having a compound eye configuration capable of reducing deviation that occurs between images according to distances to objects, and an electronic apparatus including the imaging device.

### Solutions to Problems

An imaging device according to the present disclosure for achieving the above object is the imaging device including:

a beam splitter having a light incident surface on which light from an object is incident;

a reflection mirror that returns light transmitted through the beam splitter to the beam splitter side;

a first imaging part including a first lens, the first imaging part being arranged on a first emission surface side of the beam splitter in which the light from the light incident surface side is reflected and emitted; and

a second imaging part including a second lens, the second imaging part being arranged on a second emission surface side of the beam splitter in which the light from the reflection mirror side is reflected and emitted,

in which an optical distance of the light from the light incident surface to the first lens is set to be substantially equal to an optical distance of the light from the light incident surface to the second lens.

An electronic apparatus according to the present disclosure for achieving the above object is

the electronic apparatus provided with an imaging device,

the imaging device including:

a beam splitter having a light incident surface on which light from an object is incident;

a reflection mirror that returns light transmitted through the beam splitter to the beam splitter side;

a first imaging part including a first lens, the first imaging part being arranged on a first emission surface side of the beam splitter in which the light from the light incident surface side is reflected and emitted; and

a second imaging part including a second lens, the second imaging part being arranged on a second emission surface side of the beam splitter in which the light from the reflection mirror side is reflected and emitted,

in which an optical distance of the light from the light incident surface to the first lens is set to be substantially equal to an optical distance of the light from the light incident surface to the second lens.

### BRIEF DESCRIPTION OF DRAWINGS

FIG. 1 is a schematic diagram for explaining a configuration of an imaging device according to a first embodiment of the present disclosure.

FIG. 2 is a schematic diagram for explaining a configuration of an imaging device of a reference example.

FIG. 3 is a diagram for explaining an image formation state in the imaging device of the reference example. FIG. 3A is a schematic diagram for explaining an image formation state of a first imaging part in the imaging device of the reference example. FIG. 3B is a schematic diagram for explaining an image formation state of a second imaging part in the imaging device of the reference example.

FIG. 4 is a diagram for explaining an image formation state in the imaging device according to the first embodiment. FIG. 4A is a schematic diagram for explaining an image formation state of a first imaging part. FIG. 4B is a schematic diagram for explaining an image formation state of a second imaging part.

FIG. 5 is a diagram for explaining image processing in the imaging device according to the first embodiment. FIG. 5A is a schematic diagram for explaining a configuration of an image processing unit. FIG. 5B is a schematic diagram for explaining operation of the image processing unit.

FIG. 6 is a schematic diagram for explaining a configuration of an imaging device according to a second embodiment of the present disclosure.

FIG. 7 is a diagram for explaining an image formation state in the imaging device according to the second embodiment. FIG. 7A is a schematic diagram for explaining an image formation state of a first imaging part. FIG. 7B is a schematic diagram for explaining an image formation state of a second imaging part.

FIG. 8 is a diagram for explaining an image formation state in the imaging device according to the second embodiment at the closest distance at which an image can be captured. FIG. 8A is a schematic diagram for explaining an image formation state of the first imaging part. FIG. 8B is a schematic diagram for explaining an image formation state of the second imaging part.

FIG. 9 is a schematic diagram for explaining a configuration of an imaging device according to a third embodiment of the present disclosure.

FIG. 10 is a schematic diagram for explaining a configuration of an imaging device according to a fourth embodiment of the present disclosure.

FIG. 11 is a block diagram showing an example of a schematic configuration of a vehicle control system.

FIG. 12 is an explanatory view showing an example of installation positions of out-of-vehicle information detection parts and imaging parts.

FIG. 13 is a schematic diagram for explaining an image formation state of an imaging device in which a pair of imaging parts are arranged side by side.

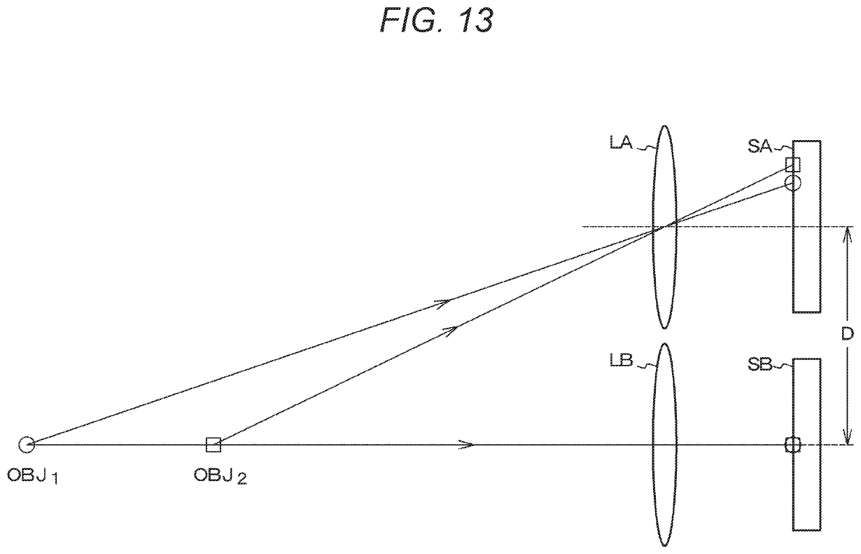

FIG. 14 is a schematic diagram for explaining a structure of an imaging device using a beam splitter.

### MODES FOR CARRYING OUT THE INVENTION

Hereinafter, the present disclosure will be described on the basis of embodiments with reference to the drawings. The present disclosure is not limited to the embodiments, and various numerical values, materials, and the like in the embodiments are examples. In the following description, the same elements or elements having the same functions are denoted by the same reference symbols, without redundant description. Note that the description will be given in the following order.

1. Description of Imaging Device and Electronic Apparatus in General According to the Present Disclosure

2. First Embodiment

3. Second Embodiment

4. Third Embodiment

5. Fourth Embodiment

6. Fifth Embodiment

7. Sixth Embodiment: Application Example

8. Others

[Description of Imaging Device and Electronic Apparatus in General According to the Present Disclosure]

In an imaging device according to the present disclosure or an imaging device used in an electronic apparatus according to the present disclosure (hereinafter, there are cases where these are simply referred to as an imaging device of the present disclosure),

it can be configured that

a beam splitter is a cube type with a square cross section, and

when a length of one side of the cross section of the beam splitter is represented by a symbol L,

a refractive index of a material forming the beam splitter is represented by a symbol n,

a distance between the beam splitter and a reflection mirror is represented by a symbol a, and

a distance between a second emission surface and an entrance pupil of a second lens is represented by a symbol b,

an optical distance between a first emission surface and an entrance pupil of a first lens is set to be substantially 2a+nL+b.

In this case,

it can be configured that

when an object distance that is the closest distance is represented by a symbol OD′,

the number of pixels in an X direction and a Y direction of a second imaging part is represented by symbols 2Px and 2Py,

a focal length of the first lens is represented by a symbol f₁, and

a focal length of the second lens is represented by a symbol f₂,

in a case where f₁≤f₂ and the optical distance between the first emission surface and the entrance pupil of the first lens is 2a+nL+Δz+b,

the symbol Δz satisfies the following equation,

$$\sqrt{{Px}^{2} + {Py}^{2}} ( 1 - \frac{{OD}^{′} + 2 a + 2 nL + b}{{OD}^{′} + 2 a + 2 nL + Δ z + b} ) < 1.$$

Alternatively, in this case,

it can be configured that

when an object distance that is the closest distance is represented by the symbol OD′,

the number of pixels in an X direction and a Y direction of a second imaging part is represented by symbols 2Px and 2Py,

a pixel pitch of the second imaging part is represented by a symbol d,

a focal length of the first lens is represented by a symbol f₁,

a focal length of the second lens is represented by a symbol f₂,

a numerical aperture of the second lens is represented by a symbol NA, and

a wavelength of light to be detected is represented by a symbol λ,

in a case where f₁≤f₂ and the optical distance between the first emission surface and the entrance pupil of the first lens is 2a+nL+Δz+b,

the symbol Δz satisfies the following equation,

$$d \sqrt{{Px}^{2} + {Py}^{2}} ( 1 - \frac{{OD}^{′} + 2 a + 2 nL + b}{{OD}^{′} + 2 a + 2 nL + Δ z + b} ) < 1.22 \frac{λ}{NA} .$$

In the imaging device according to the present disclosure having various preferable configurations described above,

it can be configured that

a glass material is arranged between the first emission surface and the entrance pupil of the first lens, and

when a refractive index of the glass material is expressed using a symbol n′, a length of the glass material in an axial direction is set to (2a+nL+b)/n′.

In the imaging device according to the present disclosure having various preferable configurations described above,

it can be configured that

the reflection mirror is arranged in contact with a surface of the beam splitter.

In the imaging device according to the present disclosure having various preferable configurations described above,

it can be configured that

an image processing unit that processes an image on the basis of a first image acquired by a first imaging part and a second image acquired by the second imaging part is further included.

In this case,

it can be configured that

the image processing unit includes

a size matching part that matches the first image acquired by the first imaging part and the second image acquired by the second imaging part to the same size, and

an image signal processing part that performs signal processing on the basis of image signals of the first image and the second image of the same size.

The beam splitter used in the imaging device and the electronic apparatus of the present disclosure including the above-described preferable configurations (hereinafter, there are cases where these may be simply referred to as the present disclosure) has a function of splitting a light beam into two. The beam splitter includes a prism or the like including an optical material such as glass. In a case of the cube type, inclined surfaces of two right-angled prisms are joined to each other, and an optical thin film for splitting light into approximately half is formed on the inclined surface of the one prism. The beam splitter may be a non-polarization type or a polarization type. Note that an optical member such as a λ/4 wavelength plate may be arranged on the surface of the beam splitter depending on the configuration.

A configuration of the reflection mirror is not particularly limited. For example, a metal film such as a silver (Ag) layer may be formed on a flat base material. In some cases, a metal film or the like may be formed on a base material forming the beam splitter.

The first imaging part and the second imaging part can be configured by appropriately combining lenses, imaging elements, and the like. The first lens and the second lens may include a single lens or may include a lens group.

The imaging elements used in the first imaging part and the second imaging part are not particularly limited. For example, it is possible to use an imaging element such as a CMOS sensor or CCD sensor in which pixels including photoelectric conversion elements and various pixel transistors are arranged in a two-dimensional matrix in a row direction and a column direction.

Types of images captured by the first imaging part and the second imaging part are not particularly limited. For example, both of the first imaging part and the second imaging part may capture a monochrome image or a color image, or one of the first imaging part and the second imaging part may capture a monochrome image and another thereof may capture a color image. The number and size of pixels of the imaging elements used in the first imaging part and the second imaging part may be the same or different.

As the glass material arranged between the first emission surface and the entrance pupil of the first lens, a transparent glass material or a plastic material can be exemplified. From the viewpoint of downsizing a display device, it is preferable to use a material having a large refractive index.

The image processing unit used in the imaging device of the present disclosure may be implemented as hardware or software. Furthermore, the hardware and the software may be implemented so as to cooperate with each other. A control unit that controls operation of the entire imaging device and the like is implemented in a similar manner. These can include, for example, a logic circuit, a memory circuit, or the like, and can be created using known circuit elements. The image processing unit and the like may be configured integrally with the imaging device or may be configured separately.

Examples of the electronic apparatus including the imaging device of the present disclosure include various electronic apparatuses such as an imaging system such as a digital still camera and a digital video camera, a mobile phone having an imaging function, or another device having an imaging function.

Conditions shown in various equations in the present specification are satisfied not only in a case where the equations are mathematically strictly established but also in a case where the equations are substantially established. Regarding the establishment of the equations, presence of various variations caused by design or manufacturing of the beam splitter, the reflection mirror, the first imaging part, the second imaging part, etc. is allowed. For example, an optical distance may be influenced by a wavelength of light. In such a case, a value is only required to be selected by appropriately considering implementation conditions and the like, such as using a value near an average value of a wavelength range of light to be imaged, for example.

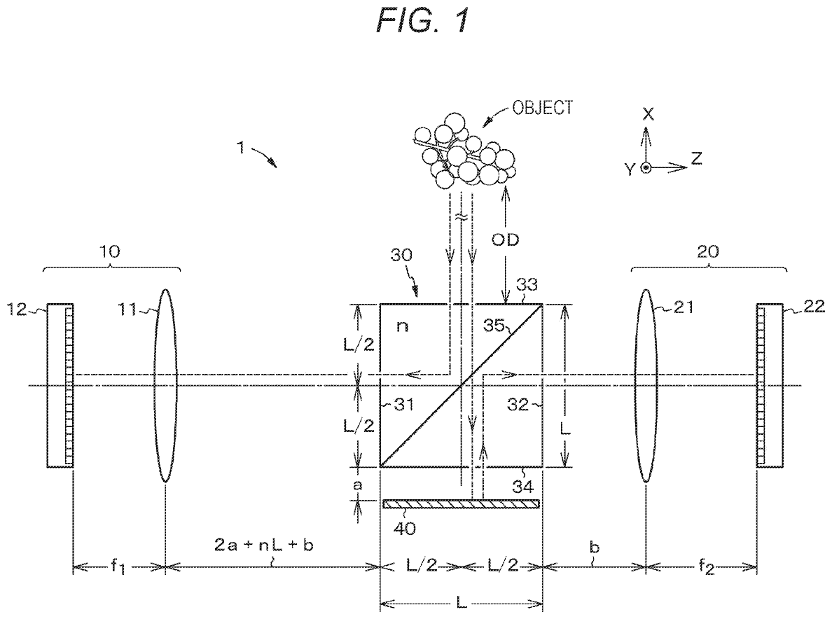

Furthermore, the drawings used in the following description are schematic. For example, FIG. 1 as described later shows a structure of an imaging device, but does not show a ratio of width, height, thickness, and the like thereof.

### First Embodiment

A first embodiment relates to an imaging device according to the present disclosure.

FIG. 1 is a schematic diagram for explaining a configuration of the imaging device according to the first embodiment of the present disclosure.

An imaging device 1 includes:

a beam splitter 30 having a light incident surface 33 on which light from an object is incident;

a reflection mirror 40 for returning light transmitted through the beam splitter 30 to the beam splitter 30 side;

a first imaging part 10 including a first lens 11, the first imaging part 10 being arranged on a first emission surface 31 side of the beam splitter 30 in which the light from the light incident surface 33 side is reflected and emitted; and

a second imaging part 20 including a second lens 21, the second imaging part 20 being arranged on a second emission surface 32 side of the beam splitter 30 in which the light from the reflection mirror 40 side is reflected and emitted.

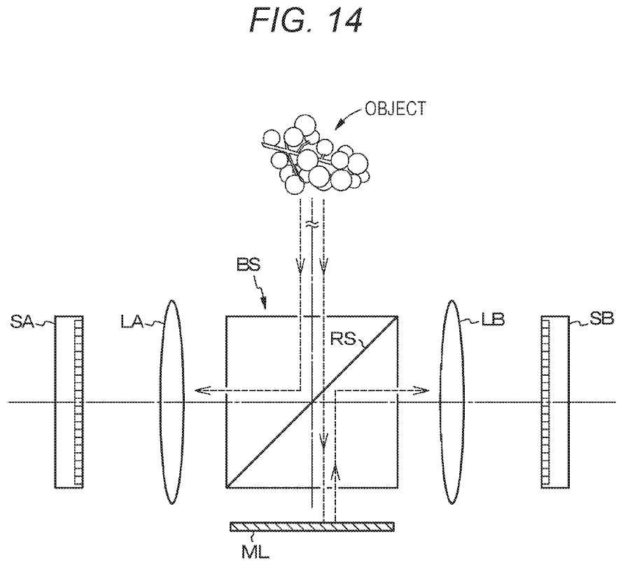

As described with reference to FIG. 14, also in the imaging device 1, a part of light incident on the beam splitter 30 is reflected by a reflection surface 35 and is emitted from the first emission surface 31. As a result, the light is incident on the first imaging part 10. On the other hand, light from a surface 34 transmitted through the beam splitter 30 is incident on the surface 34 of the beam splitter 30 again by the reflection mirror 40 and then reflected on the reflection surface 35. As a result, the light is incident on the second imaging part 20.

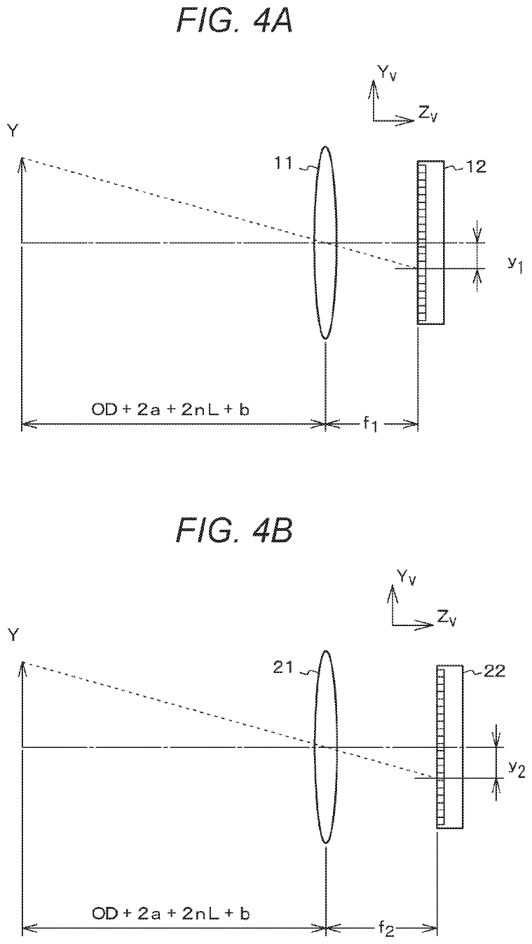

As will be described later in detail with reference to FIG. 4 described later, in the imaging device 1, an optical distance of the light from the light incident surface 33 to the first lens 11 is set to be substantially the same as an optical distance of the light from the light incident surface 33 to the second lens 21. As a result, occurrence of deviation between images depending on distances to objects is reduced, and thus it is possible to suitably perform synthesis processing of images captured by the imaging parts, for example.

In the following explanation,

a focal length of the first lens 11 is represented by a symbol f₁, and

a focal length of the second lens 21 is represented by a symbol f₂.

The first imaging part 10 further includes a first imaging element 12 that captures an image formed by the first lens 11. Also, the second imaging part 20 further includes a second imaging element 22 that captures an image formed by the second lens 21. The first imaging element 12 and the second imaging element 22 include, for example, a CMOS sensor in which pixels are arranged in a two-dimensional matrix in a row direction and a column direction. In the following description, it is assumed that both the first imaging element 12 and the second imaging element 22 are for capturing monochrome images, but this is merely an example. Furthermore, unless otherwise specified, a refractive index of space will be described as “1”.

The beam splitter 30 is a cube type having a square cross section, inclined surfaces of two right-angled prisms are joined to each other, and an optical thin film for splitting light into approximately half is formed on the inclined surface of the one prism.

In the following explanation,

a distance between the object and the light incident surface 33 of the beam splitter 30 is represented by a symbol OD,

a length of one side of the cross section of the beam splitter 30 is represented by a symbol L,

a refractive index of a material forming the beam splitter 30 is represented by a symbol n,

a distance between the beam splitter 30 and the reflection mirror 40 is represented by a symbol a, and a distance between the second emission surface 32 and an entrance pupil of the second lens 21 is represented by a symbol b. In the imaging device 1, an optical distance between the first emission surface 31 and an entrance pupil of the first lens 11 is set to be substantially 2a+nL+b.

An outline of the imaging device 1 has been described above. Next, in order to help understanding of the first embodiment, a configuration of an imaging device of a reference example and its problem will be described.

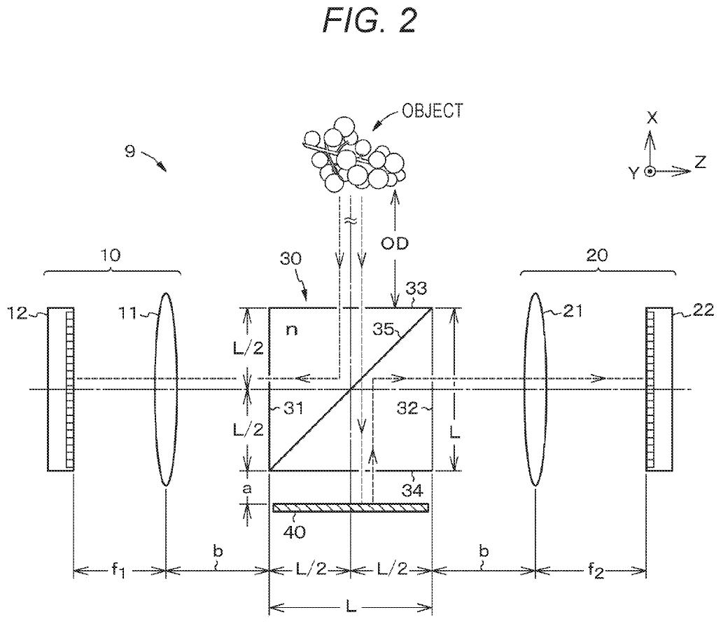

FIG. 2 is a schematic diagram for explaining the configuration of the imaging device of the reference example.

For example, an imaging device 9 of the reference example has a configuration in which a distance between an emission surface of a beam splitter 30 and a lens is reduced in order to reduce an occupied area. Specifically, the imaging system 9 shown in FIG. 2 is different from the imaging system 1 shown in FIG. 1 in that an optical distance between a first emission surface 31 and an entrance pupil of a first lens 11 is the same as a distance between a second emission surface 32 and an entrance pupil of a second lens 21, and they are both set to a symbol b.

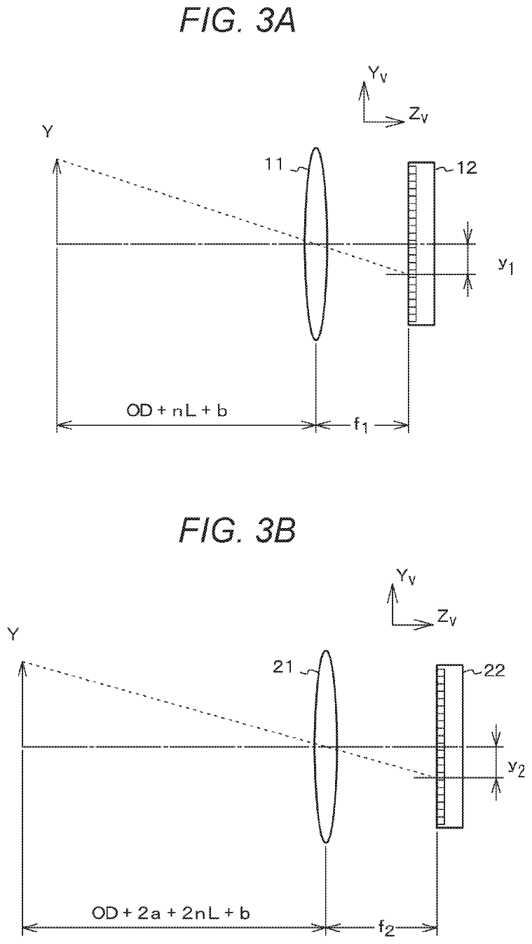

FIG. 3 is a diagram for explaining an image formation state in the imaging device of the reference example. FIG. 3A is a schematic diagram for explaining an image formation state of a first imaging part in the imaging device of the reference example. FIG. 3B is a schematic diagram for explaining an image formation state of a second imaging part in the imaging device of the reference example.

A part of light incident on the beam splitter 30 is reflected on a reflection surface, whereby the light is incident on a first imaging part 10. Therefore, from a positional relationship shown in FIG. 2, an optical distance from an object to the entrance pupil of the first lens 11 is the sum of
a distance from the object to a light incident surface 33 of the beam splitter 30

=OD,
a refractive index of the beam splitter 30×(a distance from the light incident surface 33 to a reflection surface 35+a distance from the reflection surface 35 to the first emission surface 31)

=n×(L/2+L/2)

=nL, and
a distance from the first emission surface 31 to the entrance pupil of the first lens 11

=b,

that is, [OD+nL+b].

Therefore, when the object displaced by a symbol Y from an optical axis in an image height direction is observed, an image formation state of the first imaging part 10 is as shown in FIG. 3A. A first imaging element 12 images the object at the distance [OD+nL+b] via the first lens 11 having a focal length of f₁. If an image formation position on the first imaging element 12 is represented by a symbol y₁, it can be represented by the following equation (1).

$${y}_{1} = {Yf}_{1} \frac{1}{OD + nL + b} \qquad ( 1 )$$

Light from a surface 34 transmitted through the beam splitter 30 is incident on the surface 34 of the beam splitter 30 again by a reflection mirror 40 and then reflected on the reflection surface 35. As a result, the light is incident on a second imaging part 20. Therefore, from the positional relationship shown in FIG. 2, an optical distance from the object to the entrance pupil of the second lens 21 is the sum of
the distance from the object to the light incident surface 33 of the beam splitter 30

=OD,
the refractive index of the beam splitter 30×(a distance from the light incident surface 33 to the surface 34)

=nL,
a reciprocating distance between the surface 34 and the reflection mirror 40

=2a,
the refractive index of the beam splitter 30×(a distance from the surface 34 to the reflection surface 35+a distance from the reflection surface 35 to the second emission surface 32)

=n×(L/2+L/2)

=nL, and
a distance from the second emission surface 32 to the entrance pupil of the second lens 21

=b,

that is, [OD+2a+2 nL+b].

Therefore, when the object displaced by the symbol Y from the optical axis in the image height direction is observed, an image formation state of the second imaging part 20 is as shown in FIG. 3B. The second imaging element 22 images the object located at the distance [OD+2a+2 nL+b] via the second lens 21 having a focal length of f₂. If an image formation position on the second imaging element 22 is represented by a symbol y₂, it can be represented by the following equation (2).

$${y}_{2} = {Yf}_{2} \frac{1}{OD + 2 a + 2 nL + b} \qquad ( 2 )$$

For example, in a case where f₁≤f₂, the second imaging part 20 has a narrower angle of view and a narrower imaging range than the first imaging part 10. In other words, an image on a more telephoto side is captured. Therefore, in order to match an image captured by the first imaging part 10 with an image captured by the second imaging part 20, it is necessary to perform signal processing on the image captured by the first imaging part 10 and appropriately enlarge the image. If the image is magnified by a magnification k represented by the following equation (3), the image formation position y₁ and the image formation position y₂ virtually coincide.

$$k = \frac{OD + nL + b}{OD + 2 a + 2 nL + b} \times \frac{{f}_{2}}{{f}_{1}} \qquad ( 3 )$$

Here, consider a case where a distance to the object is changed by a symbol ΔOD. At this time, a position obtained by multiplying an image formation position of the first lens 11 by the above-mentioned magnification k is represented by a symbol y₁′, and an image formation position of the second lens 21 is represented by a symbol y₂′. These can be expressed by the following equations (4) and (5), respectively.

$$\begin{matrix}{y}_{1}^{′} = {Yf}_{2} \frac{OD + nL + b}{OD + 2 a + 2 nL + b} \times \frac{1}{OD + Δ OD + nL + b} & ( 4 ) \\ {y}_{2}^{′} = {Yf}_{2} \frac{1}{OD + Δ OD + 2 a + 2 nL + b} & ( 5 )\end{matrix}$$

Here, the equations (4) and (5) do not have the same value. Therefore, in a case where enlargement processing is performed at the magnification k shown in the equation (3), if the object distance is OD, the image formation positions of the first imaging part 10 and the second imaging part 20 virtually coincide, but otherwise, do not coincide. For this reason, in a case where a scene including objects having different distances is imaged, deviation occurs on images depending on the object distances.

The configuration of the imaging device of the reference example and its problem have been described above.

As shown in FIG. 1, in the imaging device 1 according to the first embodiment, the optical distance between the first emission surface 31 and the entrance pupil of the first lens 11 is substantially set to be 2a+nL+b. With this arrangement, it is possible to solve the problem in the reference example that the deviation occurs in the images depending on the object distances.

In the imaging device 1, the optical distance from the object to the entrance pupil of the second lens 21 is similar to that in the reference example. In other words, it is [OD+2a+2 nL+b].

On the other hand, from a positional relationship shown in FIG. 1, an optical distance from the object to the entrance pupil of the first lens 11 is the sum of
a distance from the object to the light incident surface 33 of the beam splitter 30

=OD,
a refractive index of the beam splitter 30×(a distance from the light incident surface 33 to the reflection surface 35+a distance from the reflection surface 35 to the first emission surface 31)

=n×(L/2+L/2)

=nL, and
a distance from the first emission surface 31 to the entrance pupil of the first lens 11

=2a+nL+b,

that is, [OD+2a+2 nL+b].

FIG. 4 is a diagram for explaining an image formation state in the imaging device according to the first embodiment. FIG. 4A is a schematic diagram for explaining an image formation state of the first imaging part. FIG. 4B is a schematic diagram for explaining an image formation state of the second imaging part.

When an object displaced by a symbol Y from an optical axis in an image height direction is observed, an image formation state of the first imaging part 10 is as shown in FIG. 4A. The first imaging element 12 images the object located at the distance [OD+2a+2 nL+b] through the first lens 11 having the focal length of f₁. If an image formation position on the first imaging element 12 is represented by a symbol y₁, it can be represented by the following equation (6).

$${y}_{1} = {Yf}_{1} \frac{1}{OD + 2 a + 2 nL + b} \qquad ( 6 )$$

Furthermore, when the object displaced by the symbol Y from the optical axis in the image height direction is observed, an image formation state of the second imaging part 20 is as shown in FIG. 4B. The second imaging element 22 images the object located at the distance [OD+2a+2 nL+b] through the second lens 21 having the focal length of f₂. If an image formation position on the second imaging element 22 is represented by a symbol y₂, it can be represented by the following equation (7).

$${y}_{2} = {Yf}_{2} \frac{1}{OD + 2 a + 2 nL + b} \qquad ( 7 )$$

For example, in a case where f₁≤f₂, the second imaging part 20 has a narrower angle of view and a narrower imaging range than the first imaging part 10. Similarly to the case described in the reference example, if the image is magnified by a magnification k represented by the following equation (8), the image formation position y₁ and the image formation position y₂ virtually coincide.

$$k = \frac{{f}_{2}}{{f}_{1}} \qquad ( 8 )$$

Here, consider a case where a distance to the object is changed by a symbol DOD. At this time, a position obtained by multiplying an image formation position of the first lens 11 by the above-mentioned magnification k is represented by a symbol y₁′, and an image formation position of the second lens 21 is represented by a symbol y₂′. These can be expressed by the following equations (9) and (10), respectively.

$$\begin{matrix}{y}_{1}^{′} = {Yf}_{2} \frac{1}{OD + Δ OD + 2 a + 2 nL + b} & ( 9 ) \\ {y}_{2}^{′} = {Yf}_{2} \frac{1}{OD + Δ OD + 2 a + 2 nL + b} & ( 10 )\end{matrix}$$

The equations (9) and (10) have the same value. Therefore, if enlargement processing is performed at the magnification k represented by the equation (8), the image formation positions of the first imaging part 10 and the second imaging part 20 virtually coincide, regardless of the object distance. For this reason, even in a case where a scene including objects having different distances is imaged, deviation does not occur on images according to the object distances.

As described above, the imaging device 1 can favorably perform image matching. Also, it can be configured that the imaging device 1 further includes an image processing unit that processes an image on the basis of a first image acquired by the first imaging part 10 and a second image acquired by the second imaging part 20. In a similar manner, the configuration applies to other embodiments as described later.

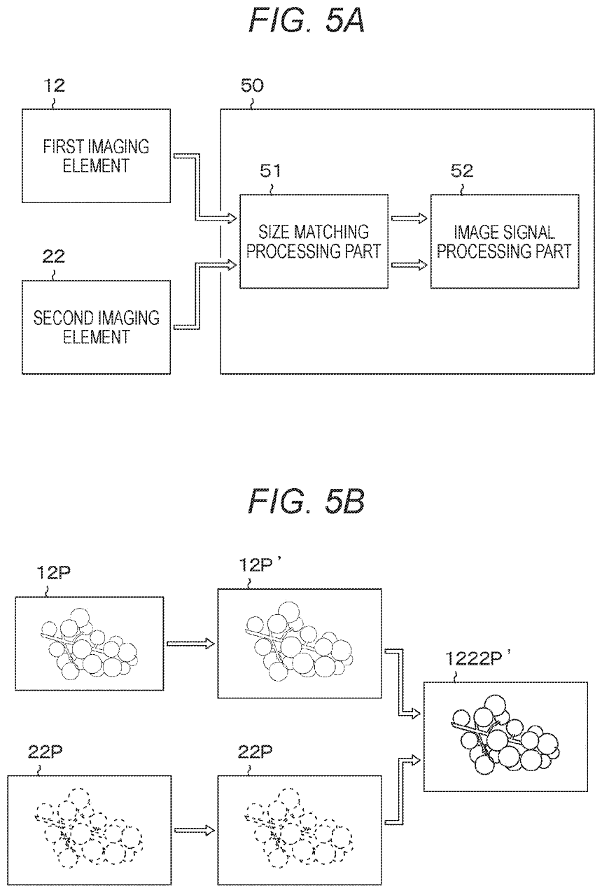

FIG. 5 is a diagram for explaining image processing in the imaging device according to the first embodiment. FIG. 5A is a schematic diagram for explaining a configuration of the image processing unit. FIG. 5B is a schematic diagram for explaining operation of the image processing unit.

As shown in FIG. 5A, an image processing unit 50 includes a size matching part 51 that matches a first image acquired by the first imaging part 10 and a second image acquired by the second imaging part 20 to the same size, and an image signal processing part 52 that performs signal processing on the basis of image signals of the first image and the second image having the same size.

Operation of the image processing unit 50 will be described with reference to FIG. 5B. The size matching part 51 performs enlargement processing on a first image 12P acquired by the first imaging part 10, for example, on the basis of the magnification k represented by the above equation (8).

The image signal processing part 52 appropriately performs signal processing on the basis of an image signal of a first image 12P′ subjected to the enlargement processing and an image signal of a second image 22P acquired by the second imaging part 20. For example, for example, processing of synthesizing a plurality of images to improve S/N and processing of adding color information to a monochrome image to synthesize a color image are performed to output a processed image 1222P′.

The imaging device according to the first embodiment has been described above. In the imaging device according to the first embodiment, the magnification at the time of performing the enlargement processing is constant regardless of the object distance. As a result, it is possible to suitably perform synthesis processing of the images captured by the imaging parts, for example.

### Second Embodiment

A second embodiment also relates to an imaging device according to the present disclosure.

In the first embodiment, a case where the optical distance between the first emission surface and the entrance pupil of the first lens is 2a+nL+b has been described. The second embodiment is a modification of the first embodiment and is different in that a range of Δz is defined in a case where an optical distance has deviation of Δz.

Considering a pixel size of an imaging element and an optical image formation limit, even if slight deviation occurs on an optical distance, an acquired image may not be affected at all. In the second embodiment, the range of Δz is defined in consideration of the pixel size of the imaging element.

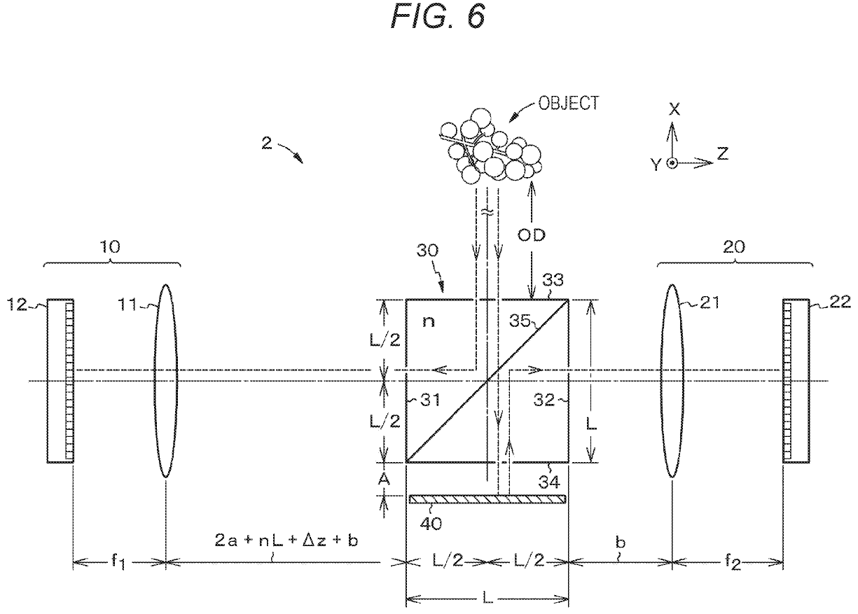

FIG. 6 is a schematic diagram for explaining a configuration of the imaging device according to the second embodiment of the present disclosure.

In the imaging device 1 shown in FIG. 1, the optical distance between the first emission surface 31 and the entrance pupil of the first lens 11 has been 2a+nL+b. In contrast, an imaging device 2 shown in FIG. 6 is different in that an optical distance between a first emission surface 31 and an entrance pupil of a first lens 11 is 2a+nL+Δz+b. The other elements are similar to the elements described in the first embodiment, and thus description thereof will be omitted.

In the imaging device 2 according to the second embodiment,

when an object distance that is the closest distance is represented by a symbol OD′,

the number of pixels in an X direction and a Y direction of a second imaging part 20 is represented by symbols 2Px and 2Py,

a focal length of the first lens 11 is represented by a symbol f₁, and

a focal length of a second lens 21 is represented by a symbol f₂,

in a case where f₁≤f₂ and the optical distance between the first emission surface 31 and the entrance pupil of the first lens 11 is 2a+nL+Δz+b,

the symbol Δz satisfies the following equation,

$$\sqrt{{Px}^{2} + {Py}^{2}} ( 1 - \frac{{OD}^{′} + 2 a + 2 nL + b}{{OD}^{′} + 2 a + 2 nL + Δ z + b} ) < 1.$$

Hereinafter, the second embodiment will be described in detail with reference to the drawings.

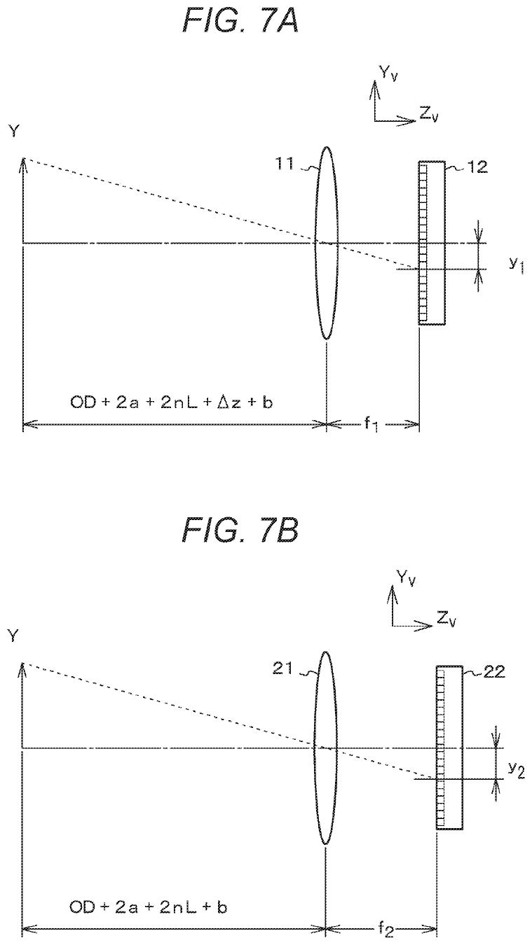

FIG. 7 is a diagram for explaining an image formation state in the imaging device according to the second embodiment. FIG. 7A is a schematic diagram for explaining an image formation state of a first imaging part. FIG. 7B is a schematic diagram for explaining an image formation state of the second imaging part.

As is clear from FIG. 7A, when an object displaced by a symbol Y from an optical axis in an image height direction is observed, an image formation state of a first imaging part 10 is as shown in FIG. 7A. If an image formation position on a first imaging element 12 is represented by a symbol y₁, it can be represented by the following equation (11).

$${y}_{1} = {Yf}_{1} \frac{1}{OD + 2 a + 2 nL + Δ z + b} \qquad ( 11 )$$

Furthermore, as is clear from FIG. 7B, when the object displaced by the symbol Y from the optical axis in the image height direction is observed, an image formation state of the second imaging part 20 is as shown in FIG. 7B. If an image formation position on a second imaging element 22 is represented by a symbol y₁, it can be represented by the following equation (12).

$${y}_{2} = {Yf}_{2} \frac{k}{OD + 2 a + 2 nL + b} \qquad ( 12 )$$

Here, consider setting magnification of an image with reference to the time of imaging at infinity. At infinity, OD>>Δz. Therefore, the above equation (11) can be approximated as the following equation (13).

$${y}_{1} ≅ {Yf}_{1} \frac{1}{OD + 2 a + 2 nL + b} \qquad ( 13 )$$

From the above equations (12) and (13), a coefficient k at the time of performing enlargement processing can be represented as the following equation (14).

$$k = \frac{{f}_{2}}{{f}_{1}} \qquad ( 14 )$$

In general, the closest distance at which an image can be captured is set to an optical system of an imaging device due to restrictions such as lens performance.

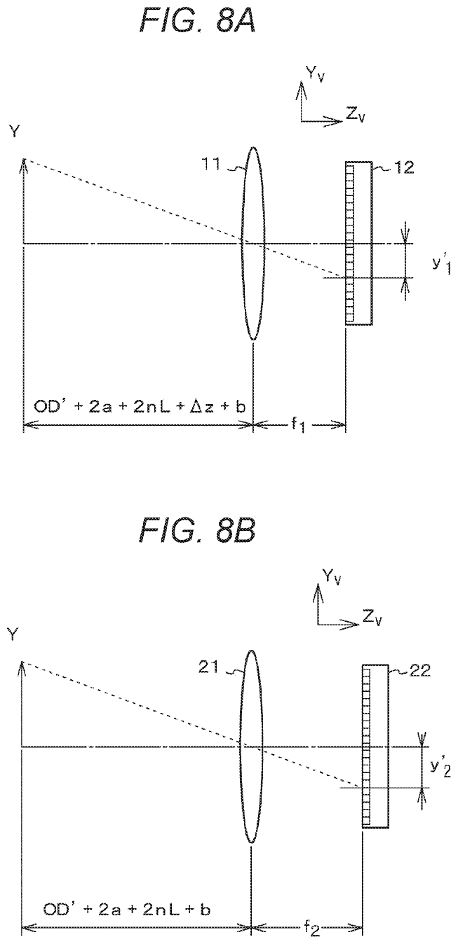

FIG. 8 is diagram for explaining an image formation state in the imaging device according to the second embodiment at the closest distance at which an image can be captured. FIG. 8A is a schematic diagram for explaining an image formation state of the first imaging part. FIG. 8B is a schematic diagram for explaining an image formation state of the second imaging part.

A distance of an object that is in the closest state is represented by a symbol OD′, an image height of the first imaging element 12 is represented by a symbol y₁′, and an image height of the second imaging element 22 is represented by a symbol y₂′. At this time, the image heights y₁′ and y₂′ can be expressed by the following equations (15) and (16), respectively.

$$\begin{matrix}{y}_{1}^{′} = {Yf}_{1} \frac{1}{{OD}^{′} + 2 a + 2 nL + Δ z + b} & ( 15 ) \\ {y}_{2}^{′} = {Yf}_{2} \frac{1}{{OD}^{′} + 2 a + 2 nL + b} & ( 16 )\end{matrix}$$

Here, a virtual image formation position obtained by multiplying the equation (15) by the above equation (14) is expressed by the following equation (17).

$${y}_{1}^{′} = {Yf}_{2} \frac{1}{{OD}^{′} + 2 a + 2 nL + Δ z + b} \qquad ( 17 )$$

A difference between the above equations (16) and (17) is an amount of position deviation when images are matched. If the amount of position deviation is represented by a symbol Δy, it is represented by the following equation (18).

$$\begin{matrix}Δ y = {y}_{2}^{′} - {y}_{1}^{′} \\ = {Yf}_{2} ( \frac{1}{{OD}^{′} + 2 a + 2 nL + b} - \frac{1}{{OD}^{′} + 2 a + 2 nL + Δ z + b} )\end{matrix} \qquad ( 18 )$$

When the number of pixels in an X direction and a Y direction in the second imaging part 20, more specifically, the second imaging element 22 of the second imaging part 20 is represented by symbols 2Px and 2Py and a pixel pitch thereof is represented by a symbol d, Δy described above becomes maximum in a case where the image height is maximum. For example, in a case where the number of pixels is 1000×1000 and the pixel pitch is 1 micrometer, the maximum image height is (500²+500²)^{1/2} micrometers. A symbol Y is represented by the following equation (19).

$$Y = \frac{d \sqrt{{Px}^{2} + {Py}^{2}}}{{f}_{2}} ( {OD}^{′} + 2 a + 2 nL + b ) \qquad ( 19 )$$

From the above equations (18) and (19), Δy is expressed by the following equation (20).

$$Δ y = d \sqrt{{Px}^{2} + {Py}^{2}} ( 1 - \frac{{OD}^{′} + 2 a + 2 nL + b}{{OD}^{′} + 2 a + 2 nL + Δ z + b} ) \qquad ( 20 )$$

Here, if Δy is smaller than the pixel pitch, an error based on it cannot be detected. Therefore, good alignment can be performed by satisfying the following equation (21).

$$d \sqrt{{Px}^{2} + {Py}^{2}} ( 1 - \frac{{OD}^{′} + 2 a + 2 nL + b}{{OD}^{′} + 2 a + 2 nL + Δ z + b} ) < d \qquad ( 21 )$$

Then, the following equation (22) is obtained by dividing both sides of the equation (21) by the symbol d.

$$\sqrt{{Px}^{2} + {Py}^{2}} ( 1 - \frac{{OD}^{′} + 2 a + 2 nL + b}{{OD}^{′} + 2 a + 2 nL + Δ z + b} ) < 1 \qquad ( 22 )$$

If the symbol Δz is in a range that satisfies this equation, an error based on it cannot be detected, and good alignment can be performed.

### Third Embodiment

A third embodiment also relates to an imaging device according to the present disclosure.

The third embodiment is also a modification of the first embodiment and is different in that an optical distance has deviation such as Δz.

As described above, in consideration of a pixel size of an imaging element and an optical image formation limit, even if slight deviation occurs on an optical distance, an acquired image may not be affected at all. In the third embodiment, a range of Δz is defined in consideration of optical performance.

Regarding a schematic configuration diagram of an imaging device 3 according to the third embodiment, the imaging device 2 in FIG. 6 may be read as the imaging device 3. Constituent elements are similar to those described in the second embodiment, and thus description thereof will be omitted.

In the imaging device 3 according to the third embodiment,

when an object distance that is the closest distance is represented by a symbol OD′,

the number of pixels in an X direction and a Y direction of a second imaging part 20 is represented by symbols 2Px and 2Py,

a pixel pitch of the second imaging part 20 is represented by a symbol d,

a focal length of a first lens 11 is represented by a symbol f₁,

a focal length of a second lens 21 is represented by a symbol f₂,

a numerical aperture of the second lens 21 is represented by a symbol NA, and

a wavelength of light to be detected is represented by a symbol λ,

in a case where f₁≤f₂ and an optical distance between a first emission surface 31 and an entrance pupil of the first lens 11 is 2a+nL+Δz+b,

the symbol Δz satisfies the following equation,

$$d \sqrt{{Px}^{2} + {Py}^{2}} ( 1 - \frac{{OD}^{′} + 2 a + 2 nL + b}{{OD}^{′} + 2 a + 2 nL + Δ z + b} ) < 1.22 \frac{λ}{NA} .$$

Hereinafter, the third embodiment will be described in detail.

The equation (22) in the second embodiment has been derived by noting that if Δy is smaller than the pixel pitch d, the error based on it cannot be detected. On the other hand, in the third embodiment, it has been noted that if Δy is smaller than optical diffraction limit performance, it can be treated as a sufficiently small error. Specifically, the following equation (23) has been derived as an equation representing that the equation (21) derived in the second embodiment is smaller than 1.22λ/NA that gives an Airy disk diameter.

$$d \sqrt{{Px}^{2} + {Py}^{2}} ( 1 - \frac{{OD}^{′} + 2 a + 2 nL + b}{{OD}^{′} + 2 a + 2 nL + Δ z + b} ) < 1.22 \frac{λ}{NA} . \qquad ( 23 )$$

If the symbol Δz is in a range that satisfies this equation, an error based on it can be treated as being sufficiently small, and good alignment can be performed.

### Fourth Embodiment

A fourth embodiment also relates to an imaging device according to the present disclosure. A main difference from the first embodiment is that a glass material is arranged between a first emission surface and an entrance pupil of a first lens.

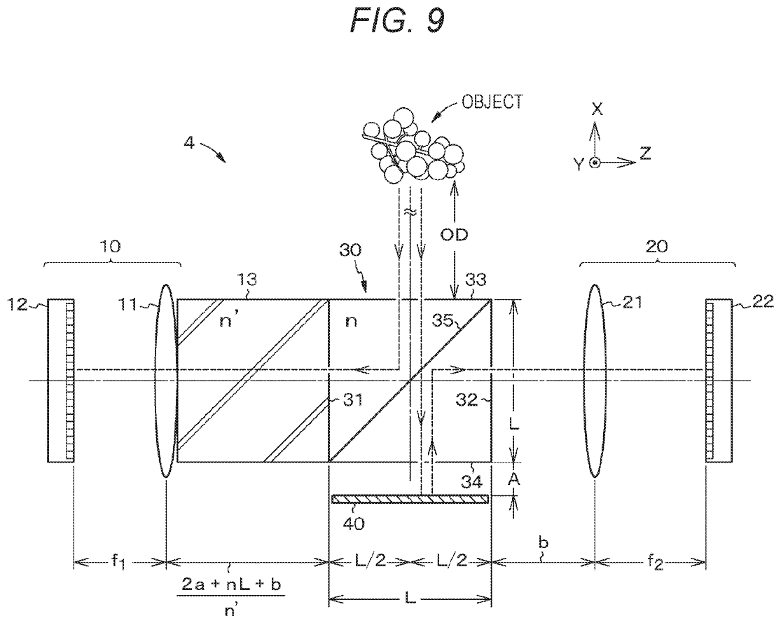

FIG. 9 is a schematic diagram for explaining a configuration of the imaging device according to the fourth embodiment of the present disclosure.

In the imaging device 1 shown in FIG. 1, a refractive index of a space between the first emission surface 31 and the entrance pupil of the first lens 11 has been “1”. On the other hand, in an imaging device 4 shown in FIG. 9,

there are differences such that

the glass material is arranged between a first emission surface 31 and an entrance pupil of a first lens 11, and

when a refractive index of the glass material is expressed using a symbol n′, a length of the glass material in an axial direction is set to (2a+nL+b)/n′. The other elements are similar to the elements described in the first embodiment, and thus description thereof will be omitted.

In the imaging device 4, physical lengths of the first emission surface 31 and the first lens 11 can be made shorter than those in the first embodiment. Furthermore, a relationship between optical distances is similar to that of the first embodiment. Therefore, it is possible to perform good alignment similar to that in the first embodiment. Moreover, it is possible to further shorten a total length of the imaging device.

Note that, in FIG. 9, a glass material 13 and a beam splitter 30 are shown as separate members, but in some cases, the glass material 13 and a triangular prism forming the beam splitter 30 may be integrally formed. Furthermore, a gap whose width is negligible may exist between the first lens 11 and the glass material 13.

### Fifth Embodiment

A fifth embodiment also relates to an imaging device according to the present disclosure. A difference from the first embodiment is that a reflection mirror is arranged in contact with a surface of a beam splitter.

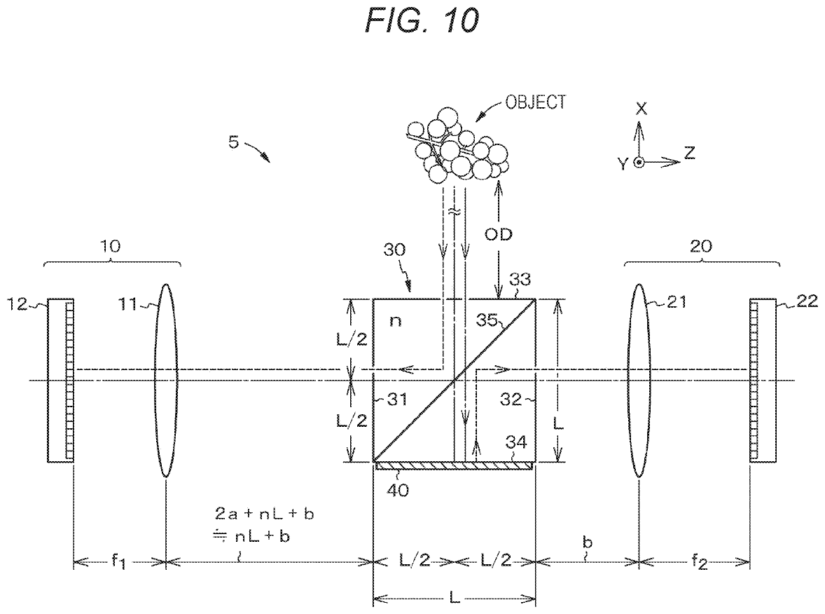

FIG. 10 is a schematic diagram for explaining a configuration of the imaging device according to the fifth embodiment of the present disclosure.

In the first embodiment, the optical distance between the first emission surface and the entrance pupil of the first lens is set to be substantially 2a+nL+b. Therefore, if the symbol a is reduced, the distance between the first emission surface and the first lens becomes narrower, which is advantageous for downsizing of the entire imaging device.

In an imaging device 5 shown in FIG. 10, a reflection mirror 40 is arranged in contact with a surface of a beam splitter 30. Therefore, it can be treated as the symbol a=0, and an overall size of the imaging device can be reduced.

The reflection mirror 40 and the beam splitter 30 may be separate bodies or may be integrated. For example, a surface 34 of the beam splitter 30 can be coated to form the reflection mirror 40. Furthermore, it may be configured that a A/4 wavelength plate is provided with an optical material such as a QWP film between the beam splitter 30 and the reflection mirror 40.

### Sixth Embodiment: Application Example

The technology according to the present disclosure can be applied to various products. For example, the technology according to the present disclosure may be realized as a device mounted on any type of a moving body such as an automobile, an electric vehicle, a hybrid electric vehicle, a motorcycle, a bicycle, a personal mobility, an airplane, a drone, a ship, a robot, a construction machine, and an agricultural machine (a tractor).

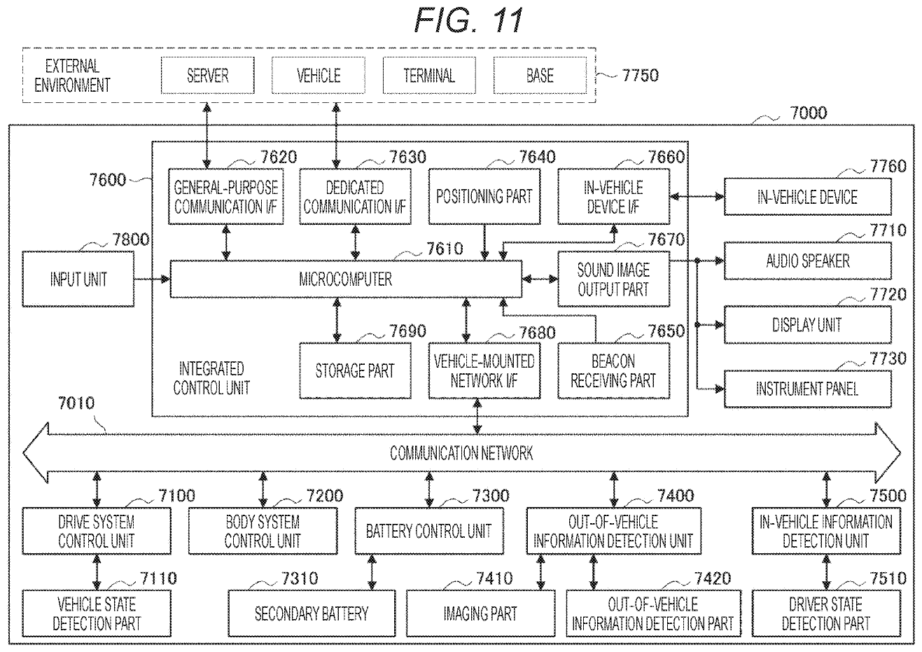

FIG. 11 is a block diagram illustrating a schematic configuration example of a vehicle control system 7000 which is an example of a moving body control system to which the technology according to the present disclosure can be applied. The vehicle control system 7000 includes a plurality of electronic control units connected via a communication network 7010. In the example shown in FIG. 11, the vehicle control system 7000 includes a drive system control unit 7100, a body system control unit 7200, a battery control unit 7300, an out-of-vehicle information detection unit 7400, an in-vehicle information detection unit 7500, and an integrated control unit 7600. The communication network 7010 connecting these plurality of control units may be, for example, a vehicle-mounted communication network conforming to any standard such as a controller area network (CAN), a local interconnect network (LIN), a local area network (LAN), or FlexRay (registered trademark).

Each control unit includes a microcomputer that performs arithmetic processing according to various programs, a storage part that stores a program executed by the microcomputer or a parameter and the like used for various calculations, and a driving circuit that drives a device to be variously controlled. Each control unit includes a network I/F for performing communication with the other control units via the communication network 7010, and includes a communication I/F for performing communication with devices, sensors, or the like inside and outside a vehicle by wired or wireless communication. In FIG. 11, a microcomputer 7610, a general-purpose communication I/F 7620, a dedicated communication I/F 7630, a positioning part 7640, a beacon receiving part 7650, an in-vehicle device I/F 7660, a sound image output part 7670, a vehicle-mounted network I/F 7680, and a storage part 7690 are illustrated as a functional configuration of the integrated control unit 7600. The other control units each include a microcomputer, a communication I/F, a storage part, and the like in a similar manner.

The drive system control unit 7100 controls operation of devices related to a drive system of the vehicle according to various programs. For example, the drive system control unit 7100 functions as a control device for a driving force generation device for generating driving force of the vehicle such as an internal combustion engine or a driving motor, a driving force transmission mechanism for transmitting driving force to wheels, a steering mechanism that adjusts a steering angle of the vehicle, and a brake device that generates brake force of the vehicle, and the like. The drive system control unit 7100 may have a function as a control device for an antilock brake system (ABS), an electronic stability control (ESC), or the like.

A vehicle state detection part 7110 is connected to the drive system control unit 7100. The vehicle state detection part 7110 includes, for example, at least one of a gyro sensor that detects angular velocity of shaft rotary motion of a vehicle body, an acceleration sensor that detects acceleration of a vehicle, or a sensor for detecting an operation amount of an accelerator pedal, an operation amount of a brake pedal, a steering angle of a steering wheel, an engine speed, a wheel rotation speed, or the like. The drive system control unit 7100 performs arithmetic processing using a signal input from the vehicle state detection part 7110, and controls the internal combustion engine, the driving motor, an electric power steering device, the brake device, or the like.

The body system control unit 7200 controls operation of various devices mounted on the vehicle body according to various programs. For example, the body system control unit 7200 functions as a control device for a keyless entry system, a smart key system, a power window device, or various lamps such as a head lamp, a back lamp, a brake lamp, a blinker, or a fog lamp. In this case, radio waves or signals of various switches transmitted from a portable device that substitutes for a key can be input to the body system control unit 7200. The body system control unit 7200 receives the input of these radio waves or signals, and controls the door lock device, the power window device, the lamp, and the like of the vehicle.

The battery control unit 7300 controls a secondary battery 7310 that is a power supply source of the driving motor according to various programs. For example, information such as battery temperature, battery output voltage, or remaining capacity of a battery is input to the battery control unit 7300 from a battery device including the secondary battery 7310. The battery control unit 7300 performs arithmetic processing using these signals, and performs temperature control of the secondary battery 7310 or control of a cooling device and the like provided in the battery device.

The out-of-vehicle information detection unit 7400 detects information outside the vehicle on which the vehicle control system 7000 is mounted. For example, at least either an imaging part 7410 or an out-of-vehicle information detection part 7420 is connected to the out-of-vehicle information detection unit 7400. The imaging part 7410 includes at least one of a time of flight (ToF) camera, a stereo camera, a monocular camera, an infrared camera, or another camera. The out-of-vehicle information detection part 7420 includes, for example, at least either an environment sensor for detecting current weather or weather conditions or a surrounding information detection sensor for detecting other vehicles, an obstacle, a pedestrian, or the like around the vehicle equipped with the vehicle control system 7000.

The environment sensor may be, for example, at least one of a raindrop sensor for detecting rainy weather, a fog sensor for detecting fog, a sunshine sensor for detecting a degree of sunshine, or a snow sensor for detecting snowfall. The surrounding information detection sensor may be at least one of an ultrasonic sensor, a radar device, or a light detection and ranging or laser imaging detection and ranging (LIDAR) device. These imaging part 7410 and out-of-vehicle information detection part 7420 may be provided as independent sensors or devices, or may be provided as an integrated device of a plurality of sensors or devices.

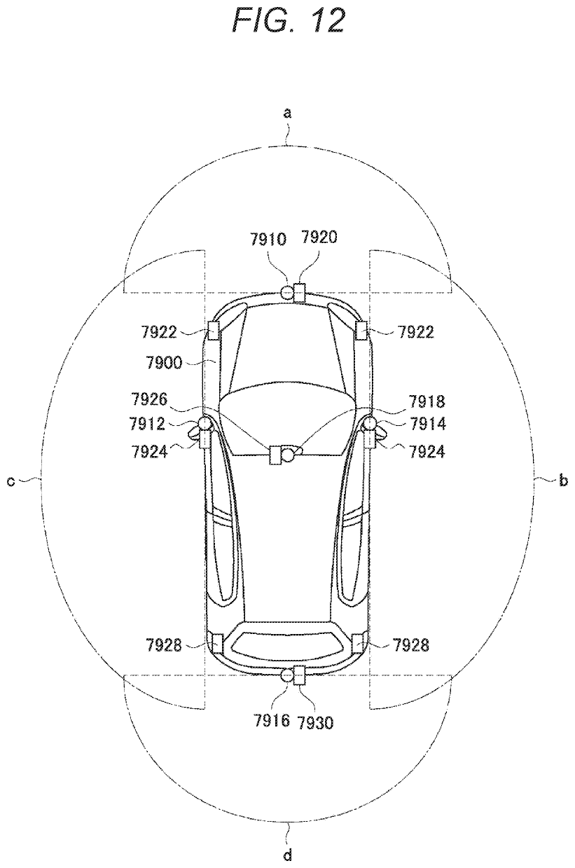

Here, FIG. 12 shows an example of installation positions of the imaging part 7410 and the out-of-vehicle information detection part 7420. Imaging parts 7910, 7912, 7914, 7916, 7918 are provided in, for example, at least one of a front nose, a side mirror, a rear bumper, a back door, or an upper part of a windshield in a vehicle interior of a vehicle 7900. The imaging part 7910 provided in the front nose and the imaging part 7918 provided at the upper part of the windshield in the vehicle interior mainly acquire images in front of the vehicle 7900. The imaging parts 7912 and 7914 provided in the side mirrors mainly acquire images of sides of the vehicle 7900. The imaging part 7916 provided in the rear bumper or the back door mainly acquires an image behind the vehicle 7900. The imaging part 7918 provided at the upper part of the windshield in the vehicle interior is mainly used for detecting a preceding vehicle, a pedestrian, an obstacle, a traffic light, a traffic sign, a lane, or the like.

Note that FIG. 12 shows an example of an imaging range of each of the imaging parts 7910, 7912, 7914, and 7916. An imaging range a indicates an imaging range of the imaging part 7910 provided in the front nose, imaging ranges b and c indicate imaging ranges of the imaging parts 7912 and 7914 provided in the side mirrors, respectively, and an imaging range d indicates an imaging range of the imaging part 7916 provided in the rear bumper or the back door. For example, a bird's-eye view image of the vehicle 7900 viewed from above can be obtained by superimposing image data captured by the imaging parts 7910, 7912, 7914, and 7916.

Out-of-vehicle information detection parts 7920, 7922, 7924, 7926, 7928, and 7930 provided in the front, the rear, the sides, corners, and the upper part of the windshield in the vehicle interior of the vehicle 7900, may be, for example, ultrasonic sensors or radar devices. The out-of-vehicle information detection parts 7920, 7926, 7930 provided in the front nose, the rear bumper, the back door, and the upper part of the windshield in the vehicle interior of the vehicle 7900 may be, for example, LIDAR devices. These out-of-vehicle information detection parts 7920 to 7930 are mainly used for detecting a preceding vehicle, a pedestrian, an obstacle, or the like.

Returning to FIG. 11, the description will be continued. The out-of-vehicle information detection unit 7400 causes the imaging part 7410 to capture an image outside the vehicle, and receives data of the captured image. Further, the out-of-vehicle information detection unit 7400 receives detected information from the connected out-of-vehicle information detection part 7420. In a case where the out-of-vehicle information detection part 7420 is an ultrasonic sensor, a radar device, or a LIDAR device, the out-of-vehicle information detection unit 7400 transmits ultrasonic waves, electromagnetic waves, or the like, and receives information on received reflected waves. The out-of-vehicle information detection unit 7400 may perform object detection processing or distance detection processing of a person, a vehicle, an obstacle, a sign, a character on a road surface, or the like on the basis of the received information. The out-of-vehicle information detection unit 7400 may perform environment recognition processing for recognizing rainfall, fog, road surface conditions, or the like on the basis of the received information. The out-of-vehicle information detection unit 7400 may calculate a distance to an object outside the vehicle on the basis of the received information.

Further, the out-of-vehicle information detection unit 7400 may perform image recognition processing or distance detection processing for recognizing a person, a vehicle, an obstacle, a sign, a character on a road surface, or the like on the basis of the received image data. The out-of-vehicle information detection unit 7400 may generate a bird's-eye view image or a panoramic image by performing processing such as distortion correction or alignment on the received image data and synthesizing image data captured by the different imaging parts 7410. The out-of-vehicle information detection unit 7400 may perform viewpoint conversion processing using the image data captured by the different imaging parts 7410.

The in-vehicle information detection unit 7500 detects information inside the vehicle. For example, a driver state detection part 7510 that detects a state of a driver is connected to the in-vehicle information detection unit 7500. The driver state detection part 7510 may include a camera that captures an image of the driver, a biological sensor that detects biological information of the driver, a microphone that collects sounds in the vehicle interior, or the like. The biological sensor is provided on, for example, a seat surface, a steering wheel, or the like and detects biological information of a passenger sitting on the seat or a driver gripping the steering wheel. The in-vehicle information detection unit 7500 may calculate a degree of fatigue or concentration of the driver or may determine whether or not the driver has fallen asleep on the basis of detected information input from the driver state detection part 7510. The in-vehicle information detection unit 7500 may perform processing such as noise canceling processing on collected sound signals.

The integrated control unit 7600 controls overall operation in the vehicle control system 7000 according to various programs. An input unit 7800 is connected to the integrated control unit 7600. The input unit 7800 is implemented by, for example, a device that can be operated by a passenger, such as a touch panel, a button, a microphone, a switch, or a lever. Data obtained by sound recognition of sound input by the microphone may be input to the integrated control unit 7600. The input unit 7800 may be, for example, a remote control device using infrared rays or other radio waves, or an external connection device such as a mobile phone or a personal digital assistant (PDA) corresponding to the operation of the vehicle control system 7000. The input unit 7800 may be, for example, a camera, in which case the passenger can input information by gesture. Alternatively, data obtained by detecting movement of a wearable device worn by the passenger may be input. Moreover, the input unit 7800 may include, for example, an input control circuit that generates an input signal on the basis of information input by the passenger and the like using the above-described input unit 7800 and outputs the input signal to the integrated control unit 7600. By operating the input unit 7800, the passenger and the like input various data to the vehicle control system 7000 or instruct processing operation.

The storage part 7690 may include a read only memory (ROM) that stores various programs executed by a microcomputer, and a random access memory (RAM) that stores various parameters, calculation results, sensor values, or the like. Furthermore, the storage part 7690 may be realized by a magnetic storage device such as a hard disc drive (HDD), a semiconductor storage device, an optical storage device, a magneto-optical storage device, or the like.

The general-purpose communication I/F 7620 is a general-purpose communication I/F that mediates communication with various devices existing in an external environment 7750. The general-purpose communication I/F 7620 may implement cellular communication protocols such as global system of mobile communications (GSM) (registered trademark), WiMAX (registered trademark), and long term evolution (LTE) (registered trademark) or LTE-Advanced (LTE-A), or other wireless communication protocols such as wireless LAN (also referred to as Wi-Fi (registered trademark)) and Bluetooth (registered trademark). The general-purpose communication I/F 7620 may be connected to a device (for example, an application server or a control server) existing on an external network (for example, the Internet, a cloud network, or an operator-specific network) via, for example, a base station or an access point. Furthermore, the general-purpose communication I/F7620 may be connected to, for example, a terminal existing near the vehicle (for example, a terminal of a driver, a pedestrian, or a store, or a machine type communication (MTC) terminal) using peer to peer (P2P) technology.

The dedicated communication I/F 7630 is a communication I/F that supports a communication protocol defined for use in the vehicle. The dedicated communication I/F 7630 may implement, for example, a standard protocol such as wireless access in vehicle environment (WAVE), which is a combination of lower layer IEEE802.11p and upper layer IEEE1609, dedicated short range communications (DSRC), or a cellular communication protocol. The dedicated communication I/F 7630 typically performs V2X communication which is a concept including one or more of vehicle to vehicle communication, vehicle to infrastructure communication, vehicle to home communication, and vehicle to pedestrian communication.

The positioning part 7640 executes positioning by receiving, for example, a global navigation satellite system (GNSS) signal from a GNSS satellite (for example, a global positioning system (GPS) signal from a GPS satellite), and generates position information including latitude, longitude, and altitude of the vehicle. Note that the positioning part 7640 may specify a current position by exchanging signals with a wireless access point, or may obtain position information from a terminal having a positioning function, such as a mobile phone, a PHS, or a smartphone.

The beacon receiving part 7650 receives, for example, radio waves or electromagnetic waves transmitted from a wireless station and the like installed on a road, and acquires information such as a current position, traffic congestion, suspension of traffic, or required time. Note that the function of the beacon receiving part 7650 may be included in the dedicated communication I/F 7630 described above.

The in-vehicle device I/F 7660 is a communication interface that mediates connection between the microcomputer 7610 and various in-vehicle devices 7760 existing in the vehicle. The in-vehicle device I/F7660 may establish wireless connection using a wireless communication protocol such as a wireless LAN, Bluetooth (registered trademark), near field communication (NFC), or wireless USB (WUSB). Furthermore, the in-vehicle device I/F7660 may establish wired connection such as a universal serial bus (USB), a high-definition multimedia interface (HDMI) (registered trademark), a mobile high-definition link (MHL), or the like via a connection terminal (not shown) (and a cable if necessary). The in-vehicle device 7760 may include, for example, at least one of a mobile device or a wearable device possessed by a passenger or an information device carried in or attached to the vehicle. Furthermore, the in-vehicle device 7760 may include a navigation device that searches for a route to an arbitrary destination. The in-vehicle device I/F 7660 exchanges control signals or data signals with these in-vehicle devices 7760.

The vehicle-mounted network I/F 7680 is an interface that mediates communication between the microcomputer 7610 and the communication network 7010. The vehicle-mounted network I/F 7680 transmits and receives signals and the like in accordance with a predetermined protocol supported by the communication network 7010.

The microcomputer 7610 of the integrated control unit 7600 controls the vehicle control system 7000 in accordance with various programs on the basis of information acquired via at least one of the general-purpose communication I/F 7620, the dedicated communication I/F 7630, the positioning part 7640, the beacon receiving part 7650, the in-vehicle device I/F 7660, or the vehicle-mounted network I/F 7680. For example, the microcomputer 7610 may calculate a control target value of the driving force generation device, the steering mechanism, or the brake device on the basis of the acquired information inside and outside the vehicle and output a control command to the drive system control unit 7100. For example, the microcomputer 7610 may perform cooperative control for the purpose of realizing functions of an advanced driver assistance system (ADAS) including vehicle collision avoidance or shock mitigation, following running based on a following distance, vehicle speed maintaining running, vehicle collision warning, or vehicle lane departure warning, and the like. Furthermore, the microcomputer 7610 may perform cooperative control for the purpose of automatic driving and the like, that is, autonomously traveling without depending on driver's operation, by controlling the driving force generation device, the steering mechanism, the brake device, or the like on the basis of the acquired information around the vehicle.

On the basis of the information acquired through at least one of the general-purpose communication I/F 7620, the dedicated communication I/F 7630, the positioning part 7640, the beacon receiving part 7650, the in-vehicle device I/F 7660, or the vehicle-mounted network I/F 7680, the microcomputer 7610 may generate three-dimensional distance information between the vehicle and an object such as a surrounding structure or a person and create local map information including surrounding information of a current position of the vehicle. Furthermore, the microcomputer 7610 may predict danger such as collision between vehicles, approach of a pedestrian and the like, or entry to a closed road on the basis of the acquired information and generate a warning signal. The warning signal may be, for example, a signal for generating warning sound or lighting a warning lamp.

The sound image output part 7670 transmits an output signal of at least one of sound or an image to an output device capable of visually or audibly notifying a passenger of the vehicle or outside of the vehicle. In the example of FIG. 11, an audio speaker 7710, a display unit 7720, and an instrument panel 7730 are illustrated as the output devices. The display unit 7720 may include, for example, at least one of an on-board display or a head-up display. The display unit 7720 may have an augmented reality (AR) display function. The output device may be a device other than these devices such as a headphone, a wearable device such as a spectacle-type display worn by a passenger, a projector, or a lamp. In a case where the output device is a display device, the display device visually displays results obtained by various processing performed by the microcomputer 7610 or information received from the other control units in various formats such as text, images, tables, and graphs. Furthermore, in a case where the output device is a sound output device, the sound output device converts an audio signal including reproduced sound data, acoustic data, or the like into an analog signal and outputs it audibly.

Note that in the example shown in FIG. 11, at least two control units connected via the communication network 7010 may be integrated as one control unit. Alternatively, each control unit may be configured by a plurality of control units. Moreover, the vehicle control system 7000 may include another control unit (not shown). Furthermore, some or all of the functions performed by any of the control units in the above description may be given to the other control unit. In other words, as long as information is transmitted and received via the communication network 7010, predetermined arithmetic processing may be performed by any of the control units. Similarly, a sensor or device connected to any of the control units may be connected to the other control unit, and a plurality of control units may transmit and receive detected information to and from each other via the communication network 7010.

The technology according to the present disclosure can be applied to, for example, the imaging part of the out-of-vehicle information detection unit in the configuration described above. In other words, according to the present disclosure, the imaging device having the plurality of imaging parts can perform image processing in a state in which positional deviation between images is reduced, and thus more detailed information can be obtained.

### Configurations of the Present Disclosure

Note that the present disclosure can have the following configurations.

[A1]

An imaging device including:

a beam splitter having a light incident surface on which light from an object is incident;

a reflection mirror that returns light transmitted through the beam splitter to the beam splitter side;

a first imaging part including a first lens, the first imaging part being arranged on a first emission surface side of the beam splitter in which the light from the light incident surface side is reflected and emitted; and

a second imaging part including a second lens, the second imaging part being arranged on a second emission surface side of the beam splitter in which the light from the reflection mirror side is reflected and emitted,

in which an optical distance of the light from the light incident surface to the first lens is set to be substantially equal to an optical distance of the light from the light incident surface to the second lens.

[A2]

The imaging device according to [A1] described above, in which

the beam splitter is a cube type with a square cross section, and

when a length of one side of the cross section of the beam splitter is represented by a symbol L,

a refractive index of a material forming the beam splitter is represented by a symbol n,

a distance between the beam splitter and the reflection mirror is represented by a symbol a, and

a distance from the second emission surface to an entrance pupil of the second lens is represented by a symbol b,

an optical distance from the first emission surface to an entrance pupil of the first lens is set to be substantially 2a+nL+b.

[A3]

The imaging device according to [A2] described above, in which

when an object distance that is the closest distance is represented by a symbol OD′,

the number of pixels in an X direction and a Y direction of the second imaging part is represented by symbols 2Px and 2Py,

a focal length of the first lens is represented by a symbol f₁, and

a focal length of the second lens is represented by a symbol f₂,

in a case where f₁≤f₂ and the optical distance from the first emission surface to the entrance pupil of the first lens is 2a+nL+Δz+b,

the symbol Δz satisfies the following equation,

$$\sqrt{{Px}^{2} + {Py}^{2}} ( 1 - \frac{{OD}^{′} + 2 a + 2 nL + b}{{OD}^{′} + 2 a + 2 nL + Δ z + b} ) < 1.$$

[A4]

The imaging device according to [A2] described above, in which

when an object distance that is the closest distance is represented by a symbol OD′,

the number of pixels in an X direction and a Y direction of the second imaging part is represented by symbols 2Px and 2Py,

a pixel pitch of the second imaging part is represented by a symbol d,

a focal length of the first lens is represented by a symbol f₁,

a focal length of the second lens is represented by a symbol f₂,

a numerical aperture of the second lens is represented by a symbol NA, and

a wavelength of light to be detected is represented by a symbol λ,

in a case where f₁≤f₂ and the optical distance from the first emission surface to the entrance pupil of the first lens is 2a+nL+Δz+b,

the symbol Δz satisfies the following equation,

$$d \sqrt{{Px}^{2} + {Py}^{2}} ( 1 - \frac{{OD}^{′} + 2 a + 2 nL + b}{{OD}^{′} + 2 a + 2 nL + Δ z + b} ) < 1.22 \frac{λ}{NA} .$$

[A5]

The imaging device according to any one of [A2] to [A4] described above, in which

a glass material is arranged between the first emission surface and the entrance pupil of the first lens, and

when a refractive index of the glass material is represented by a symbol n′, a length of the glass material in an axial direction is set to (2a+nL+b)/n′.

[A6]

The imaging device according to any one of [A1] to [A5] described above, in which

the reflection mirror is arranged in contact with a surface of the beam splitter.

[A7]

The imaging device according to any one of [A1] to [A6] described above, further including:

an image processing unit that processes an image on the basis of a first image acquired by the first imaging part and a second image acquired by the second imaging part.

[A8]

The imaging device according to [A7] described above, in which

the image processing unit includes

a size matching part that matches the first image acquired by the first imaging part and the second image acquired by the second imaging part to equal size, and

an image signal processing part that performs signal processing on the basis of image signals of the first image and the second image of the equal size.

[B1]

An electronic apparatus provided with an imaging device, the imaging device including:

a beam splitter having a light incident surface on which light from an object is incident;

a reflection mirror that returns light transmitted through the beam splitter to the beam splitter side;

a first imaging part including a first lens, the first imaging part being arranged on a first emission surface side of the beam splitter in which the light from the light incident surface side is reflected and emitted; and

a second imaging part including a second lens, the second imaging part being arranged on a second emission surface side of the beam splitter in which the light from the reflection mirror side is reflected and emitted,

in which an optical distance of the light from the light incident surface to the first lens is set to be substantially equal to an optical distance of the light from the light incident surface to the second lens.

[B2]

The electronic apparatus according to [B1] described above, in which

the beam splitter is a cube type with a square cross section, and

when a length of one side of the cross section of the beam splitter is represented by a symbol L,

a refractive index of a material forming the beam splitter is represented by a symbol n,

a distance between the beam splitter and the reflection mirror is represented by a symbol a, and

a distance from the second emission surface to an entrance pupil of the second lens is represented by a symbol b,

an optical distance from the first emission surface to an entrance pupil of the first lens is set to be substantially 2a+nL+b.

[B3]

The electronic apparatus according to [B2] described above, in which

when an object distance that is the closest distance is represented by a symbol OD′,

the number of pixels in an X direction and a Y direction of the second imaging part is represented by symbols 2Px and 2Py,

a focal length of the first lens is represented by a symbol f₁, and

a focal length of the second lens is represented by a symbol f₂,

in a case where f₁≤f₂ and the optical distance from the first emission surface to the entrance pupil of the first lens is 2a+nL+Δz+b,

the symbol Δz satisfies the following equation,

$$\sqrt{{Px}^{2} + {Py}^{2}} ( 1 - \frac{{OD}^{′} + 2 a + 2 nL + b}{{OD}^{′} + 2 a + 2 nL + Δ z + b} ) < 1.$$

[B4]

The electronic apparatus according to [B2] described above, in which

when an object distance that is the closest distance is represented by a symbol OD′,

the number of pixels in an X direction and a Y direction of the second imaging part is represented by symbols 2Px and 2Py,

a pixel pitch of the second imaging part is represented by a symbol d,

a focal length of the first lens is represented by a symbol f₁,

a focal length of the second lens is represented by a symbol f₂,

a numerical aperture of the second lens is represented by a symbol NB, and

a wavelength of light to be detected is represented by a symbol λ,

in a case where f₁≤f₂ and the optical distance from the first emission surface to the entrance pupil of the first lens is 2a+nL+Δz+b,

the symbol Δz satisfies the following equation,

$$d \sqrt{{Px}^{2} + {Py}^{2}} ( 1 - \frac{{OD}^{′} + 2 a + 2 nL + b}{{OD}^{′} + 2 a + 2 nL + Δ z + b} ) < 1.22 \frac{λ}{NA} .$$

[B5]

The electronic apparatus according to any one of [B2] to [B4] described above, in which

a glass material is arranged between the first emission surface and the entrance pupil of the first lens, and

when a refractive index of the glass material is represented by a symbol n′, a length of the glass material in an axial direction is set to (2a+nL+b)/n′.

[B6]

The electronic apparatus according to any one of [B1] to [B5] described above, in which

the reflection mirror is arranged in contact with a surface of the beam splitter.

[B7]

The electronic apparatus according to any one of [B1] to [B6] described above, further including:

an image processing unit that processes an image on the basis of a first image acquired by the first imaging part and a second image acquired by the second imaging part.

[B8]

The electronic apparatus according to [B7] described above, in which

the image processing unit includes

a size matching part that matches the first image acquired by the first imaging part and the second image acquired by the second imaging part to equal size, and

an image signal processing part that performs signal processing on the basis of image signals of the first image and the second image of the equal size.

### REFERENCE SIGNS LIST

1, 2, 3, 4, 5, 9 Imaging device
10 First imaging part
11 First lens
12 First imaging element
13 Glass material
20 Second imaging part
21 Second lens
22 Second imaging element
30 Beam splitter
31 First emission surface
32 Second emission surface
33 Light incident surface
34 Surface on reflection mirror side
35 Reflection surface
40 Reflection mirror
50 Image processing unit
51 Size matching part
52 Image signal processing part

1. An imaging device comprising:
a beam splitter having a light incident surface on which light from an object is incident;
a reflection mirror that returns light transmitted through the beam splitter to the beam splitter side;
a first imaging part including a first lens, the first imaging part being arranged on a first emission surface side of the beam splitter in which the light from the light incident surface side is reflected and emitted; and
a second imaging part including a second lens, the second imaging part being arranged on a second emission surface side of the beam splitter in which the light from the reflection mirror side is reflected and emitted,
wherein an optical distance of the light from the light incident surface to the first lens is set to be substantially equal to an optical distance of the light from the light incident surface to the second lens.

2. The imaging device according to claim 1, wherein
the beam splitter is a cube type with a square cross section, and
when a length of one side of the cross section of the beam splitter is represented by a symbol L,
a refractive index of a material forming the beam splitter is represented by a symbol n,
a distance between the beam splitter and the reflection mirror is represented by a symbol a, and
a distance from the second emission surface to an entrance pupil of the second lens is represented by a symbol b,
an optical distance from the first emission surface to an entrance pupil of the first lens is set to be substantially 2a+nL+b.

3. The imaging device according to claim 2, wherein
when an object distance that is a closest distance is represented by a symbol OD′,
a number of pixels in an X direction and a Y direction of the second imaging part is represented by symbols 2Px and 2Py,
a focal length of the first lens is represented by a symbol f₁, and
a focal length of the second lens is represented by a symbol f₂,
in a case where f₁≤f₂ and the optical distance from the first emission surface to the entrance pupil of the first lens is 2a+nL+Δz+b,
the symbol Δz satisfies a following equation,
$$\sqrt{{Px}^{2} + {Py}^{2}} ( 1 - \frac{{OD}^{′} + 2 a + 2 nL + b}{{OD}^{′} + 2 a + 2 nL + Δ z + b} ) < 1.$$

4. The imaging device according to claim 2, wherein
when an object distance that is a closest distance is represented by a symbol OD′,
a number of pixels in an X direction and a Y direction of the second imaging part is represented by symbols 2Px and 2Py,
a pixel pitch of the second imaging part is represented by a symbol d,
a focal length of the first lens is represented by a symbol f₁,
a focal length of the second lens is represented by a symbol f₂,
a numerical aperture of the second lens is represented by a symbol NA, and
a wavelength of light to be detected is represented by a symbol λ,
in a case where f₁≤f₂ and the optical distance from the first emission surface to the entrance pupil of the first lens is 2a+nL+Δz+b,
the symbol Δz satisfies a following equation,
$$d \sqrt{{Px}^{2} + {Py}^{2}} ( 1 - \frac{{OD}^{′} + 2 a + 2 nL + b}{{OD}^{′} + 2 a + 2 nL + Δ z + b} ) < 1.22 \frac{λ}{NA} .$$

5. The imaging device according to claim 2, wherein
a glass material is arranged between the first emission surface and the entrance pupil of the first lens, and
when a refractive index of the glass material is represented by a symbol n′, a length of the glass material in an axial direction is set to (2a+nL+b)/n′.

6. The imaging device according to claim 1, wherein
the reflection mirror is arranged in contact with a surface of the beam splitter.

7. The imaging device according to claim 1, further comprising:
an image processing unit that processes an image on a basis of a first image acquired by the first imaging part and a second image acquired by the second imaging part.

8. The imaging device according to claim 1, wherein
the image processing unit includes
a size matching part that matches the first image acquired by the first imaging part and the second image acquired by the second imaging part to equal size, and
an image signal processing part that performs signal processing on a basis of image signals of the first image and the second image of the equal size.

9. An electronic apparatus provided with an imaging device,
the imaging device including:
a beam splitter having a light incident surface on which light from an object is incident;
a reflection mirror that returns light transmitted through the beam splitter to the beam splitter side;
a first imaging part including a first lens, the first imaging part being arranged on a first emission surface side of the beam splitter in which the light from the light incident surface side is reflected and emitted; and
a second imaging part including a second lens, the second imaging part being arranged on a second emission surface side of the beam splitter in which the light from the reflection mirror side is reflected and emitted,
wherein an optical distance of the light from the light incident surface to the first lens is set to be substantially equal to an optical distance of the light from the light incident surface to the second lens.
